(19) United States
(12) Patent Application Publication
(10) Pub. No.: US 2025/0162390 A1
(43) Pub. Date: May 22, 2025

(54) MODULAR DOOR SYSTEM FOR A TRAILER OR OTHER PROTECTED TRUCK BODY

(71) Applicant: ASSA ABLOY Entrance Systems AB, Landskrona (SE)

(72) Inventors: Richard K Hoofard, Dallas, TX (US); Stephen Kosek, Fort Worth, TX (US)

(21) Appl. No.: 18/512,786

(22) Filed: Nov. 17, 2023

(51) Int. Cl. B60J 5/10; B62D 63/08; E05F 15/00

(52) U.S. Cl. CPC B60J 5/108; B62D 63/08; E05F 15/00

(57) ABSTRACT

A modular trailer door system for an OTR trailer may include a manually operated door assembly, a manually operated lock system for locking and unlocking the manually operated door assembly, and a door frame structure configured to mount the manually operated door assembly and be removably connected to the OTR trailer.

### TECHNICAL FIELD

Example embodiments generally relate to over the road (OTR) trailers or trucks with protected body portions and, in particular, relate to a modular door system for such trailers/trucks that can be enable automated and manual operation of the same door system.

### BACKGROUND

Movement of materials and equipment in a distribution center is a significant and important component of any supply and distribution chain. Materials and equipment are routinely required to be transported many times throughout the lifecycle of the particular materials and equipment in the facility. As such, many transport systems have been developed to help efficiently move items through various modes of transportation, including transport by forklifts, pallet jacks, and conveyor systems or by manual means. One common item in many modes of transport is a pallet that is used to carry equipment and/or materials. The term “pallet” is used herein to refer to any of the various types of material handling platforms or flat transport structures that support goods in a stable fashion to facilitate transport by the transport equipment listed above.

A major portion of the lifecycle of materials and equipment noted above relates to movement of goods into and out of the facility. This movement is typically accomplished using OTR trailers (or semi-trailers) that often range in length from 20 ft to 53 ft with widths of 96 to 102 inches and heights of up to 108 inches. These OTR trailers (or simply “trailers”), such as the 53 ft dry goods trailer, typically have one of two rear door designs. The primary design is termed a “barn door” design that includes two hinged doors that are hinged at opposing outside edges and meet and latch in the middle along the centerline of the trailer. The barn door design is manually operated by a driver or dock worker. The second design is a roll up door that typically consists of a counterbalanced sectional door that moves along a track system located at the rear of the vehicle. The roll up door, which is similar to a typical residential garage door, may also be manually operated by the driver or a dock worker. However, the roll up door could be automatically operated if a motor is also included with the design. The roll up door will take up trailer space due to the need to house the tracks and provide room for internal movement of the door and, if automated, will lose even more space to the automation means in addition to adding extra weight to the trailer.

Accordingly, it may be desirable to provide an improved truck/trailer door that is operable both manually and automatically. However, example embodiments may further provide such a design without adding significant weight to the truck/trailer and without sacrificing space and therefore the capacity of the truck/trailer.

### BRIEF SUMMARY OF SOME EXAMPLES

In an example embodiment, a modular door system for an over the road (OTR) trailer or protected truck body may be provided. The system may include a manually operated door assembly, a manually operated lock system for locking and unlocking the manually operated door assembly, and a door frame structure configured to mount the manually operated door assembly and be removably connected to the OTR trailer or protected truck body.

In another example embodiment, a modular door for an OTR trailer may be provided. The modular door may include a modular door frame to selectively operably couple the modular door to a trailer frame of the trailer, a manual operation assembly including a first hinged door panel operably coupled to a first side frame member on a first lateral side of the modular door frame and a second hinged door panel operably coupled to a second side frame member on a second lateral side of the modular door frame where the first and second hinged door panels are manually operable to swing between a closed state of the modular door and a manual open state in which the first and second hinged door panels are pivoted away from each other to provide access to a cargo space of the trailer, and an automated operation assembly operable between the closed state of the modular door and an automated open state in which the modular door frame is moved relative to the trailer frame to provide access to the cargo space of the trailer while the first and second hinged door panels remain proximate to each other.

In another example embodiment, an OTR trailer may be provided. The trailer may include a trailer frame, a cargo space bounded by the trailer frame, a mobility assembly operably coupled to the trailer frame to enable mobility of the trailer frame, and a modular door providing hybrid modes of operation including a manual mode and an automated mode. The modular door may include a modular door frame to selectively operably couple the modular door to the trailer frame, a manual operation assembly comprising a first hinged door panel operably coupled to a first side frame member on a first lateral side of the modular door frame and a second hinged door panel operably coupled to a second side frame member on a second lateral side of the modular door frame where the first and second hinged door panels being manually operable to swing between a closed state of the modular door and a manual open state in which the first and second hinged door panels are pivoted away from each other to provide access to the cargo space, and an automated operation assembly that is operable between the closed state of the modular door and an automated open state in which the modular door frame is moved relative to the trailer frame to provide access to the cargo space of the trailer while the first and second hinged door panels remain proximate to each other.

In still another example embodiment,

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1 illustrates a block diagram of a modular door system in accordance with an example embodiment;

FIG. 2 shows a perspective view of the modular door operably coupled to an OTR trailer while in a closed state in accordance with an example embodiment;

FIG. 3 illustrates the modular door in a manual open state according to an example embodiment;

FIG. 4 illustrates the modular door in an automated open state according to an example embodiment;

FIG. 5 shows a set of guide members provided on the rear of the trailer to slidably receive the modular door according to an example embodiment;

FIG. 6 illustrates a rear view of the trailer showing the modular door in accordance with an example embodiment;

FIG. 7 shows a perspective view of the modular door frame according to an example embodiment;

FIG. 8 is a cross section view along line A-A′ of FIG. 6 in accordance with an example embodiment;

FIG. 9 is a cross section view along line B-B′ of FIG. 6 in accordance with an example embodiment;

FIG. 10 is a cross section view along line C-C′ of FIG. 6 in accordance with an example embodiment;

FIG. 11 illustrates another form of attachment between the modular door and the trailer frame in accordance with an example embodiment;

FIG. 12 illustrates yet another form of attachment between the modular door and the trailer frame in accordance with an example embodiment; and

FIG. 13 illustrates a locking feature that may be employed to secure the modular door to the trailer frame in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

Certain details are set forth in the following description and in the Figures to provide a thorough understanding of various embodiments of the present technology. In other instances, well-known structures, materials, operations and/or systems often associated with trailers, loading docks, etc. are not shown or described in detail in the following disclosure to avoid unnecessarily obscuring the description of the various embodiments of the technology. Those of ordinary skill in the art will recognize, however, that the present technology can be practiced without one or more of the details set forth herein, or with other structures, methods, components, and so forth.

The terminology used below is to be interpreted in its broadest reasonable manner, even though it is being used in conjunction with a detailed description of certain examples of embodiments of the technology. Indeed, certain terms may even be emphasized below; however, any terminology intended to be interpreted in any restricted manner will be overtly and specifically defined as such in this Detailed Description section.

The accompanying Figures depict embodiments of the present technology and are not intended to be limiting of its scope. The sizes of various depicted elements are not necessarily drawn to scale, and these various elements may be arbitrarily enlarged to improve legibility. Component details may be abstracted in the Figures to exclude details such as position of components and certain precise connections between such components when such details are unnecessary for a complete understanding of how to make and use the invention. Many of the details, dimensions, angles and other features shown in the Figures are merely illustrative of particular embodiments of the disclosure. Accordingly, other embodiments can have other details, dimensions, angles and features without departing from the spirit or scope of the present invention. In addition, those of ordinary skill in the art will appreciate that further embodiments of the invention can be practiced without several of the details described below. In the Figures, identical reference numbers identify identical, or at least generally similar, elements.

As noted above, manual or automated doors have up until now been binary choices. Moreover, where automation is employed, some loss of cargo space and a large increase in weight can be expected. Meanwhile, automation continues to expand within the transportation industry as autonomous vehicles continue to be discussed and developed, and efforts to automate various aspects of loading and unloading trailers also continue to be pressed forward. In spite of the push toward expansion of automation, the reality is that many destinations for shipped goods will continue to lack automation for quite some time. Thus, whereas larger and newer distribution centers can be expected to be set up for automated operations, smaller and older centers and many, many final destinations for shipped goods will continue to lack facilities to support automated operations. This could inhibit the adoption of hardware solutions that employ or support automated loading and unloading, especially as it relates to automated trailer door operation.

Accordingly, a hybrid solution that allows either manual or automated loading and unloading, which will necessarily also require a hybrid door solution, may become highly attractive. Example embodiments aim to provide a hybrid door solution that allows automated operation with respect to accessing the trailer's cargo space whenever automation can be supported, but also allows manual operation with respect to accessing the trailer's cargo space in other situations.

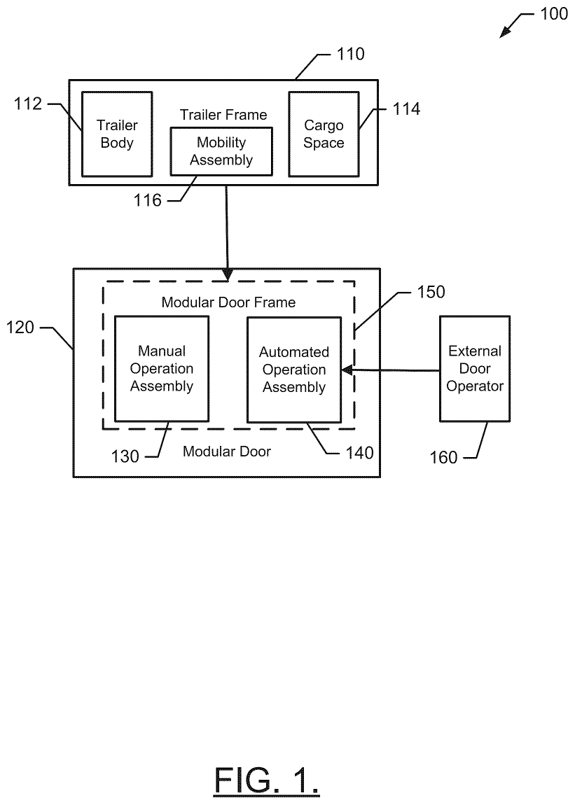

Referring to FIG. 1, a modular door system 100 may include a trailer frame 110 (e.g., of an OTR dry goods trailer) supporting a trailer body 112 that encloses a cargo space 114. The trailer frame 110 may further be supported by a mobility assembly 116 that enables rolling movement of the trailer frame 110. The modular door system 100 may also include a modular door 120. The modular door 120 may include a manual operation assembly 130 and an automated operation assembly 140, each of which is operable to alternately provide access to and prevent access to the cargo space 114 depending on whether the modular door 120 is in an open state (providing access) or a closed state (preventing access). In an example embodiment, both the manual operation assembly 130 and the automated operation assembly 140 may be provided in a single modular door frame 150 that mates with the trailer frame 110.

The manual operation assembly 130 may include hardware and components that allow for access to the cargo space 114 responsive to an operator (e.g., a driver or dock worker) manually transitioning the manual operation assembly 130 (and therefore also the modular door 120) from the closed state to the opened state. The modular door frame 150 may stay entirely attached to the trailer frame 110 without moving in both states. Meanwhile, the automated operation assembly 140 may include hardware and components that allow for access to the cargo space 114 responsive to operation of an external door operator 160 that provides power and mobility for automated transition of the automated operation assembly 140 (and therefore also the modular door 120) from the closed state to the opened state. The modular door frame 150 may, by virtue of transitioning the modular door 120 to the opened state, be physically moved relative to the trailer frame 110 and may actually be separated therefrom in some cases.

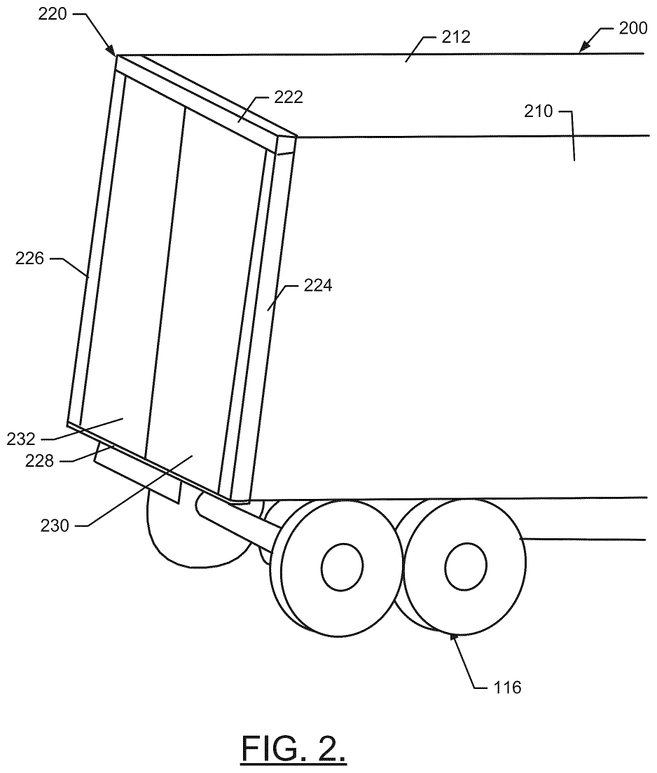

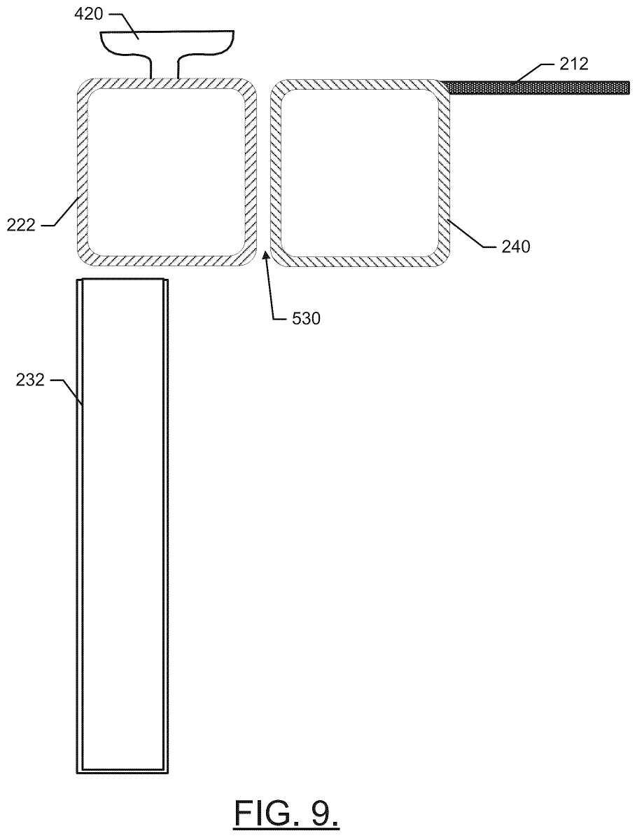

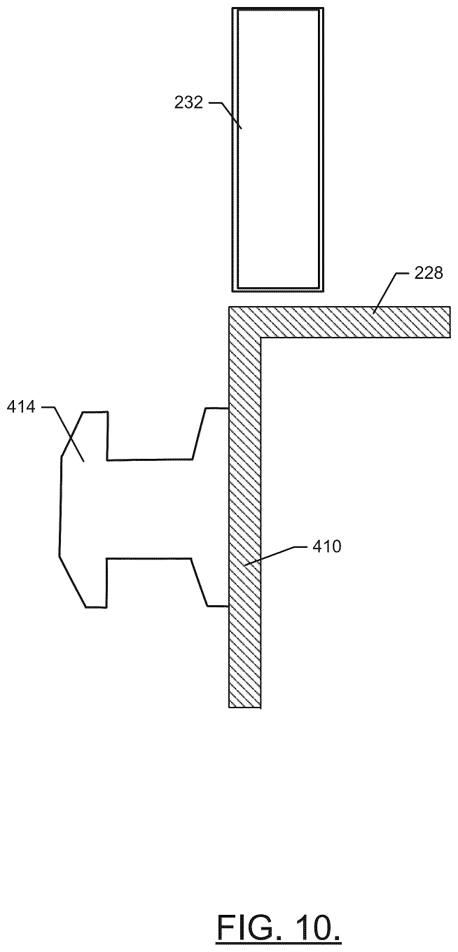

As may be appreciated from the description above, the hardware and componentry used to implement the manual operation assembly 130 and the automated operation assembly 140 may vary in example embodiments. Moreover, the external door operator 160 may also take numerous different forms such as, for example, a forklift, pallet jack, or other device capable of elevating or lifting the modular door 120 as described herein. Thus, whereas some such structures will be discussed in reference to FIGS. 2-13, it should be appreciated that the structures displayed are provided by way of example and not of limitation.

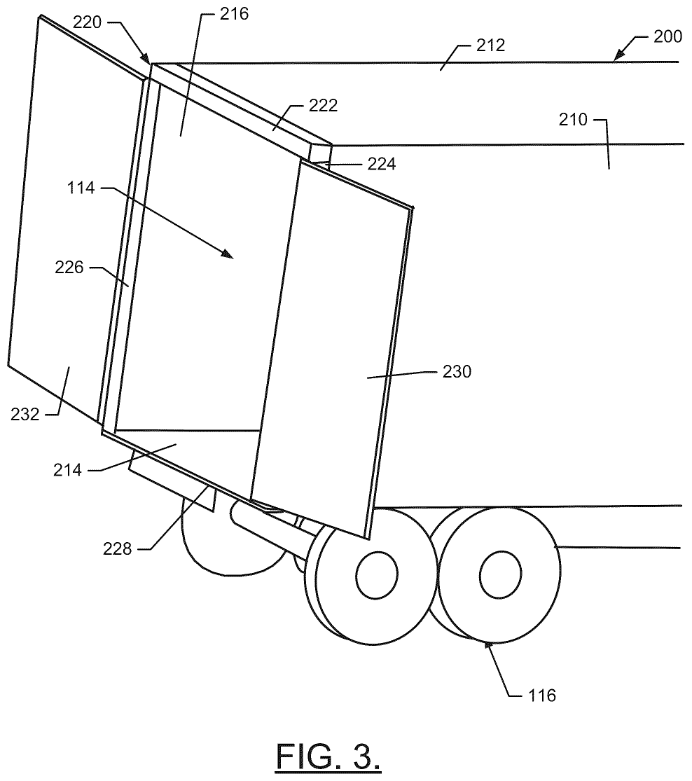

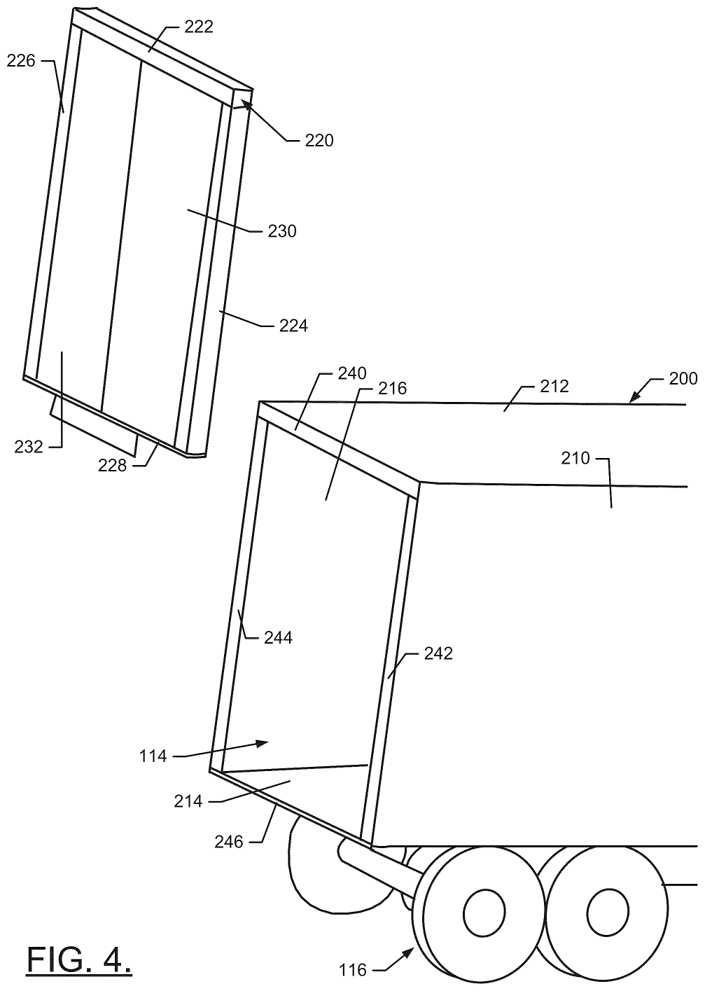

Turning first to FIGS. 2-4, a rear end of a dry goods trailer 200 is shown along with a sidewall 210 and ceiling 212, which form portions of the trailer body 112 of FIG. 1, and which, along with a front wall (not shown), floor 214 and opposing sidewall 216, enclose the cargo space 114. Modular door 220 is a specific example of the modular door 120 of FIG. 1, and is shown in the closed state in FIG. 2 and opened state in each of FIGS. 3 and 4.

The modular door frame 150 of this example includes a top frame member 222, a first side frame member 224, a second side frame member 226 and a bottom frame member 228. The top frame member 222 is connected to respective first ends of the first and second side frame members 224 and 226 at opposing ends of the top frame member 222. The bottom frame member 228 is connected to respective second ends of the first and second side frame members 224 and 226 at opposing ends of the bottom frame member 228 to define a rectangular and hollow frame through which cargo may be transitioned into and out of the cargo space 114 in the open state of the modular door 220 as shown in FIG. 3.

In this regard, the manual operation assembly 130 includes a first hinged door panel 230 and a second hinged door panel 232. The first hinged door panel 230 is operably coupled to the first side frame member 224 via a hinge assembly to allow the first hinged door panel 230 to swing about an axis parallel to a longitudinal axis of the first side frame member 224 between the closed state of FIG. 2 and the open state of FIG. 3. The second hinged door panel 232 is operably coupled to the second side frame member 226 via another hinge assembly to allow the second hinged door panel 232 to swing about an axis parallel to a longitudinal axis of the second side frame member 226 between the closed state of FIG. 2 and the open state of FIG. 3. As discussed above, the modular door frame 150 (and therefore the top frame member 222, the first side frame member 224, the second side frame member 226 and the bottom frame member 228) does not move relative to the trailer frame 110 when the manual operation assembly 130 transitions between open and closed states.

However, when the modular door 220 transitions to the open state via operation of the automated operation assembly 140, the modular door frame 150 does move relative to the trailer frame 110. In this regard, as shown in FIG. 4, the trailer frame 110 may include a trailer frame top member 240, a trailer frame first side member 242, a trailer frame second side member 244 and a trailer frame bottom member 246. The trailer frame 110 may be releasably operably coupled to the modular door frame 150 of the modular door 220 so that the modular door 220 may be moved and, in some cases, completely removed from contact with the trailer frame 110. Thus, the top frame member 222 is proximate to the trailer frame top member 240, the first side frame member 224 is proximate to the trailer frame first side member 242, the second side frame member 226 is proximate to the trailer frame second side member 244, and the bottom frame member 228 is proximate to the trailer bottom frame member 246 when the modular door 220 is in the closed position. However, in each instance, the proximities noted above are broken responsive to movement of the modular door 220 (by the external door operator 160) when the modular door 220 transitions to the open state via the automated operation assembly 140 due to the physical movement of the modular door 220.

Thus, for example, if the trailer 200 is to be loaded at a distribution center or loading dock that does not have capacity to employ an instance of the external door operator 160 or otherwise provide automation with respect to loading operations, the cargo space 114 may be filled responsive to opening the modular door 220 via the manual operation assembly 130. More specifically, the first and second hinged door panels 230 and 232 may be unlocked and swung open manually to transition the modular door 220 to the opened state shown in FIG. 3. Similar operation may be conducted at the delivery side if the receiving loading dock is not equipped to support automation with respect to unloading operations.

However, if the trailer 200 is to be loaded at a distribution center or loading dock that does have an instance of the external door operator 160 or is otherwise able to provide automation with respect to loading operations, the automated operation assembly 140 may be employed to lift the modular door 220 physically (thereby carrying the entire manual operation assembly 130 therewith) to remove the modular door frame 150 from contact with the trailer frame 110 to transition to the open state as shown in FIG. 4. Similar operation may be conducted at the delivery side if the receiving loading dock is equipped to support automation with respect to unloading operations.

Based on the description above, it can be appreciated that the open state of the modular door 220 is achieved quite differently via the manual operation assembly 130 (the open state of which is shown in FIG. 3) and via the automated operation assembly 140 (the open state of which is shown in FIG. 4). Thus, it may be appropriate to consider the open state of FIG. 3 to be a manual open state (in which the first and second hinged door panels 230 and 232 are swung open or spread apart from each other) and the open state of FIG. 4 may be considered to be an automated open state (in which the first and second hinged door panels 230 and 232 remain proximate to each other). The different open states, and differences in achieving each based on the operations employed to achieve them may be considered hybrid functions, and thus the modular door 220 may be considered to be a hybrid door with alternative modes of operation (e.g., manual and automated).

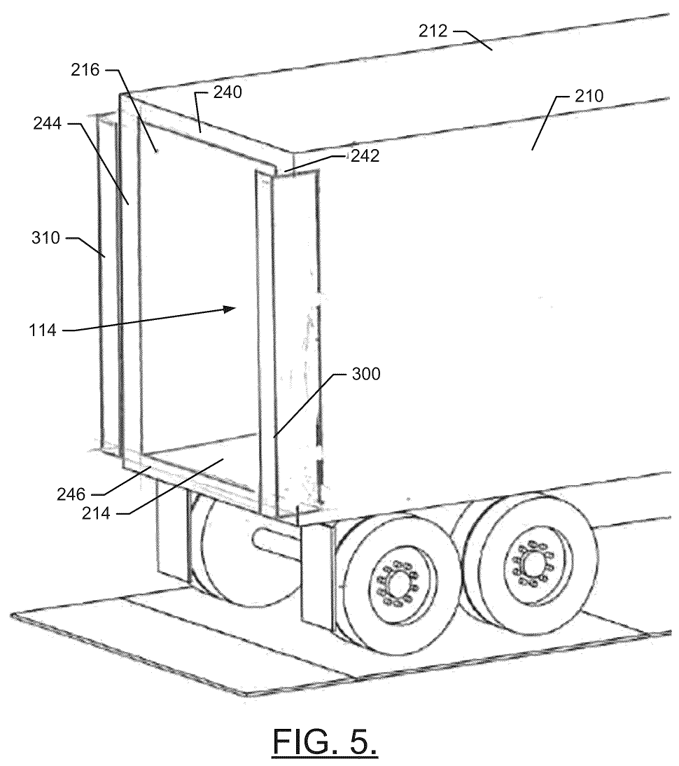

Although the structures associated with enabling releasable connection between the trailer frame 110 and the modular door frame 150 of the modular door 220 may vary, one example structure is shown in FIG. 5. In this regard, as shown in FIG. 5, a guide track may be provided for slidable connection between the trailer frame 110 and the modular door frame 150. The guide track may include a first guide member 300 attached to the trailer frame first side member 242 and a second guide member 310 attached to the trailer frame second side member 244. The first and second guide members 300 and 310 may each be L shaped brackets that extend from outer edges of the trailer frame first side member 242 and trailer frame second side member 244, respectively, to define a guide channel or slot into which the modular door 220 may be releasably retained. The L shaped brackets of the first and second guide members 300 and 310 may allow the first and second side frame members 224 and 226, respectively, to slide up and down within the first and second guide members 300 and 310. Thus, for example, for initial installation or closing after an opening operation, the modular door 220 may be aligned with the guide channel or slot and lowered therein (e.g., until the top frame member 222 is proximate to the trailer frame top member 240 and the bottom frame member 228 is proximate to the trailer bottom frame member 246) at which point the modular door 220 may be retained in the closed state. For opening, the external door operator 160 may be temporarily operably coupled to the modular door 220 and may lift the modular door 220 within the guide channel or slot until the modular door 220 can be entirely removed from contact with the first and second guide members 300 and 310. Upon removal, the situation shown in FIG. 5 will be realized and the modular door 220 is in the open state.

Thus, the example of FIG. 5 shows a relatively simple example of a sliding engagement between the modular door 220 (and particularly the modular door frame 150 thereof) and the trailer 200 (and particularly the trailer frame 110 thereof). In this regard, the modular door frame 150 may be relatively simple in construction, and the sliding medium or track may be entirely embodied at (or attached and resident at) the trailer frame 110. However, in other embodiments, the modular door frame 150 may also include hardware structured to support sliding engagement with the trailer frame 110.

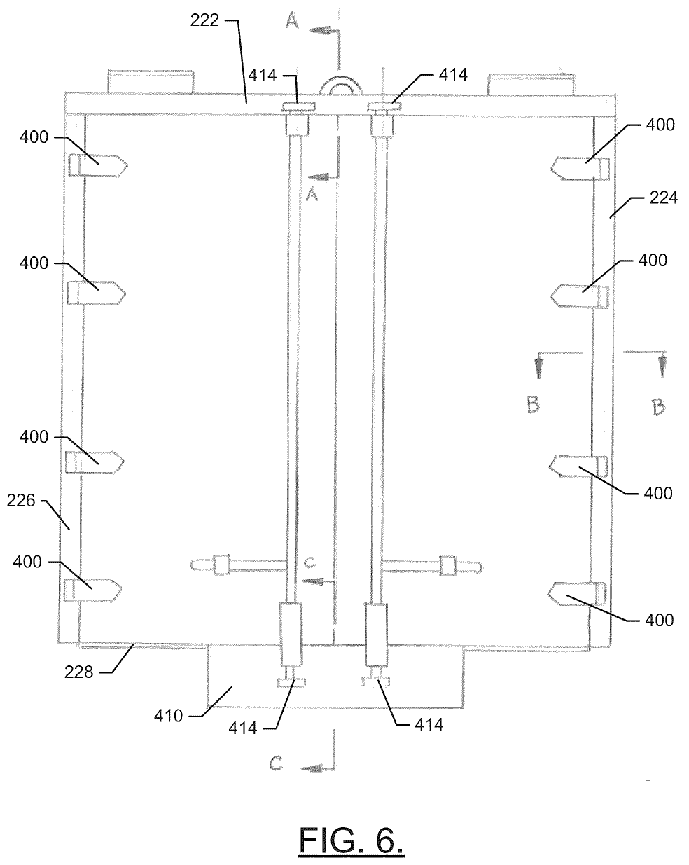

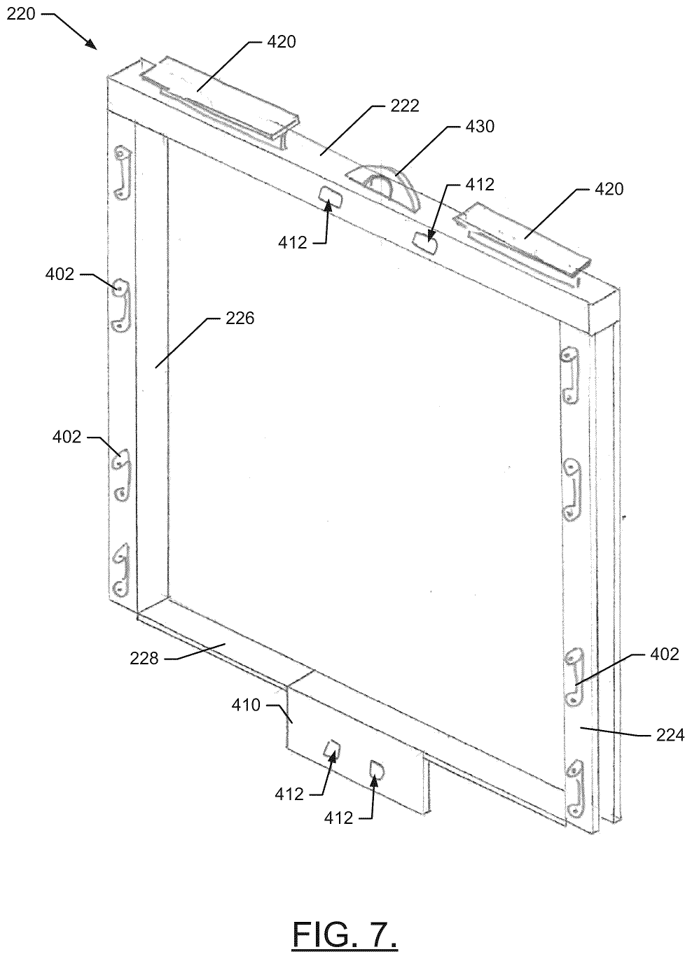

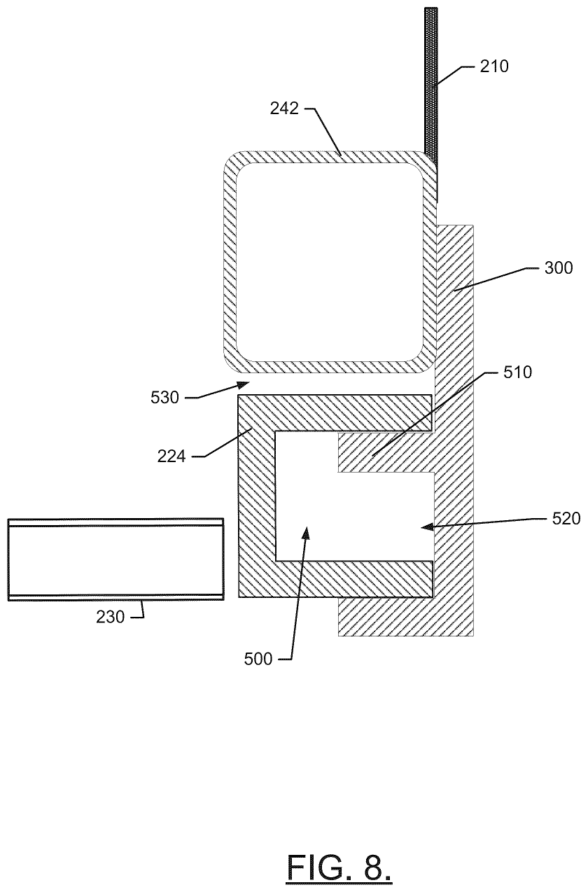

FIGS. 6 and 7 show various aspects of the modular door 220 of an example embodiment in which the modular door frame 150 includes hardware to support sliding engagement, and FIGS. 8-10 show cross section views of portions of the modular door 220 identified by section lies A-A′, B-B′ and C-C′ in FIG. 6. In this regard, as shown in FIG. 6 (which is a view of the rear portion of the trailer 200 with the modular door 220 in the closed state), hinges 400 may be provided to hingedly connect the first and second hinged door panels 230 and 232 to the first and second side frame members 224 and 226 at hinge brackets 402 shown in FIG. 7. Referring generally to FIGS. 6-10, the bottom frame member 228 may also include or be operably coupled to a locking plate 410, which may include one or more locking apertures 412 to interface with swing door pivot locks 414 that are operably coupled to the first and second hinged door panels 230 and 232 near a bottom portion thereof. The top frame member 222 may also include locking apertures 412 to interface with swing door pivot locks 414 proximate a top portion of the first and second hinged door panels 230 and 232.

The modular door 220 may also include one or more lifting members 420 that may extend from a top portion of the top frame member 222. The lifting members 420 may be welded or otherwise affixed to the top frame member 222 to enable the external door operator 160 (e.g., a forklift or lifting apparatus integrated into the loading dock or at another portion of a distribution center) to interface with the modular door 220, and may be capable of supporting the full weight of the modular door 220. Once the external door operator 160 engages the lifting members 420, the external door operator 160 may lift the entire modular door 220 for removal to the open state of FIG. 4. In some cases, the modular door 220 after removal may be stored temporarily until replaced. A storage loop 430 may be provided to receive a storage hook or other protrusion to suspend and store the modular door 220 while cargo loading ensues.

As noted above, the modular door 220 may integrate structure or hardware to facilitate sliding engagement with the trailer frame 110. FIGS. 7 and 8 show a receiving channel 500 formed in the first side frame member 224 (and a like instance of the receiving channel 500 may also be formed in the second side frame member 226). The receiving channel 500 may be shaped to receive a projection or protruding member 510 that may be formed to extend into the guide channel 520 otherwise formed by the L shaped bracket of the first guide member 300. In some cases, various ones of the components shown in FIGS. 8-10 may be provided with gaps 530 therebetween to allow for manufacturing tolerances and facilitate easy sliding. One or more, and in some cases all, of the gaps may be filled with a gasket, damping material, or other compressible material that may facilitate sliding contact or minimize friction.

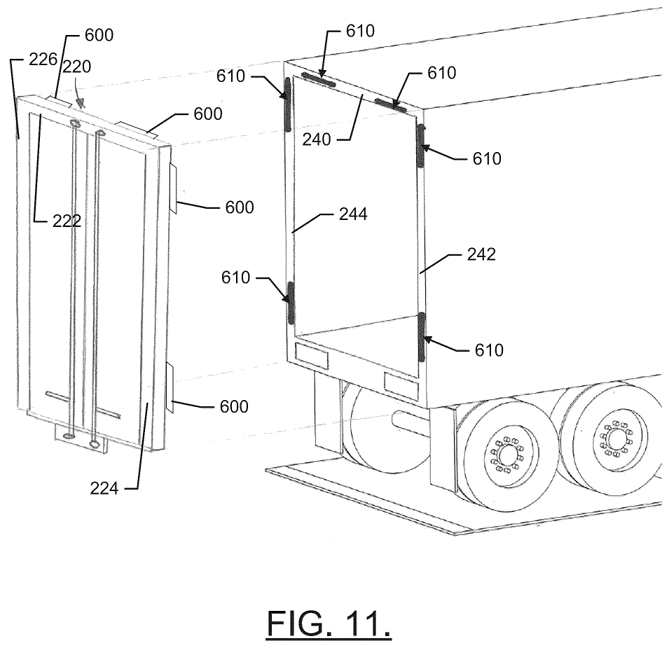

The modular door 220 may be slidably connected to the trailer 200 in the manner described above in some cases. Doing so may make a lift in the upward direction, which is easy to accomplish using a forklift or other lifting equipment, the normal movement associated with transitioning to the automated open position. However, vertical or upward movement is not strictly required. For example, FIG. 11 illustrates an example in which the modular door 220 may include projections 600 that project toward the trailer 200 to be inserted into receiving slots 610 formed in the frame members of the trailer 200 (e.g., the trailer frame top member 240, the trailer frame first side member 242, and the trailer frame second side member 244). The projections 600 may be locked into place via locking devices in the frame members of the trailer 200, or the projections 600 may hook downward to hook into the receiving slots 610.

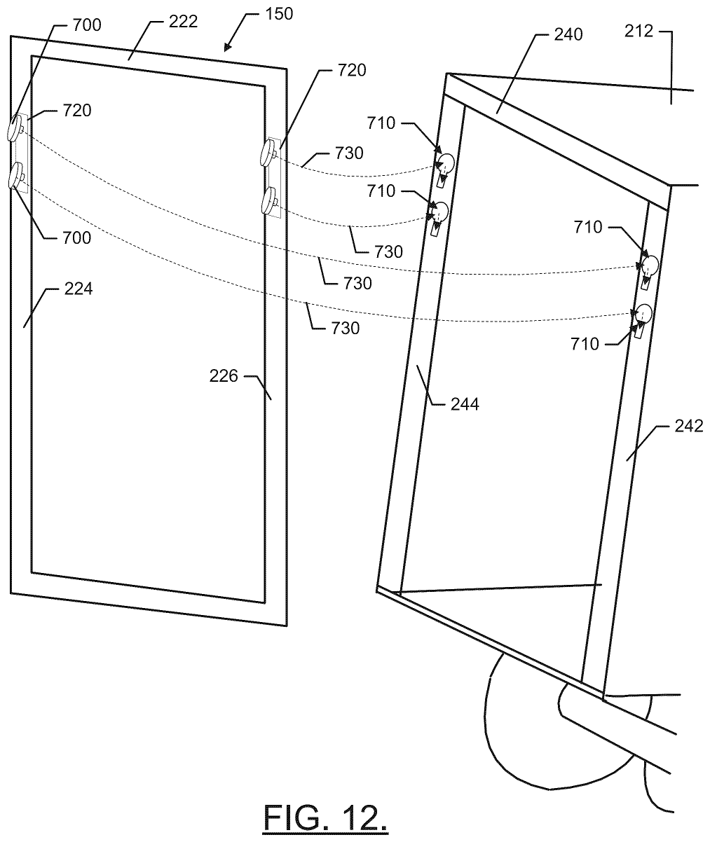

In still other cases, such as the one shown in FIG. 12, the modular door 220 may be fitted with a plurality of studs 700 that project out of a plane of the modular door frame 150 and can be received in key hole slots 710 formed in the frame members of the trailer 200. However, the locations of the studs 700 and key hole slots 710 could be reversed in some cases. Moreover, in some cases, the studs 700 may be directly welded or otherwise affixed to the frame members of the modular door frame 150 or trailer frame 110, whereas in other cases the studs 700 may be affixed to plates 720 that are thereafter welded onto frame members of the modular door frame 150 or trailer frame 110. Arrows 730 show the alignment of the studs 700 with their respective key hole slots 710 for initial alignment and then seating of the studs 700 in the key hole slots 710 to retain the modular door frame 150 proximate to the trailer frame 110 (as indicated by trailer frame top member 240, the trailer frame first side member 242, and the trailer frame second side member 244).

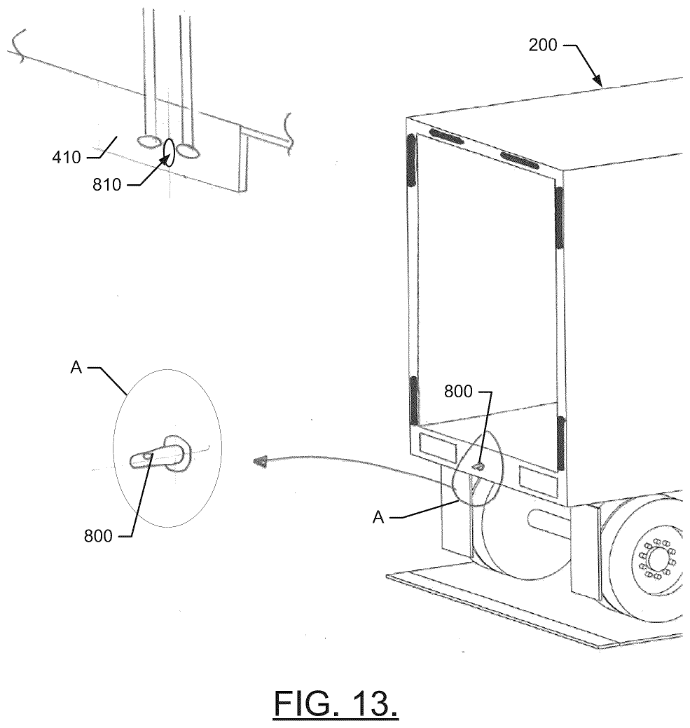

In some embodiments, a locking protrusion 800 may be provided at the trailer frame bottom member 246 to extend through a locking aperture 810 in the locking plate 410 as shown in FIG. 13. Circled region A is enlarged to show the locking protrusion 800 more clearly. In the examples of FIGS. 11-13, which do not include long sliding tracks, movement of the modular door 220 may be less than that which is required for the examples of FIGS. 2-10. Various different factors, including equipment type and availability for implementing the external door operator 160 may dictate which specific structures to choose for implementing example embodiments. However, for all cases shown in FIGS. 2-13, the extra weight added to the trailer 200 may generally be less than 80 lbs. Thus, not only does the fact that the modular door 220 has an automated open state where access to the cargo space 114 is not inhibited and not consumed by the modular door 220 or equipment that moves it create significant advantages for spatial efficiency of the design, but such design also does not appreciably decrease fuel economy by increasing weight.

Accordingly, some example embodiments may provide a modular trailer door system for an OTR trailer. The system may include a manually operated door assembly, a manually operated lock system for locking and unlocking the manually operated door assembly, and a door frame structure configured to mount the manually operated door assembly and be removably connected to the OTR trailer. The system may include a modular door that may include a modular door frame to selectively operably couple the modular door to a trailer frame of the trailer, a manual operation assembly including a first hinged door panel operably coupled to a first side frame member on a first lateral side of the modular door frame and a second hinged door panel operably coupled to a second side frame member on a second lateral side of the modular door frame where the first and second hinged door panels are manually operable to swing between a closed state of the modular door and a manual open state in which the first and second hinged door panels are pivoted away from each other to provide access to a cargo space of the trailer, and an automated operation assembly operable between the closed state of the modular door and an automated open state in which the modular door frame is moved relative to the trailer frame to provide access to the cargo space of the trailer while the first and second hinged door panels remain proximate to each other.

The modular door and/or a system including the same, or components thereof described above may be augmented or modified by altering individual features mentioned above or adding optional features. The augmentations or modifications may be performed in any combination and in any order. For example, in some cases, the automated operation assembly may include an external door operator providing power for movement of the modular door frame relative to the trailer frame. In an example embodiment, the modular door frame may move relative to the trailer frame when transitioning to the automated open state without any part of the modular door extending into the cargo space. In some cases, the modular door frame may be completely removed from contact with the trailer frame in the automated open state. In an example embodiment, the automated operation assembly may include a first guide member operably coupled to a trailer frame first side member to define a first guide channel into which the first side frame member of the modular door frame is slidably received, and a second guide member operably coupled to a trailer frame second side member to define a second guide channel into which the second side frame member of the modular door frame is slidably received. In some cases, the first and second guide members may each be L shaped brackets defining the first and second guide channels, respectively. In an example embodiment, the first and second guide members may each include a protruding member, and the protruding member may protrude into a receiving channel formed in the first and second side frame members, respectively. In some cases, one of the modular door frame or the trailer frame may include a plurality of stud projections, and the other of the trailer frame or the modular door frame may include a plurality of key hole receivers formed to receive respective instances of the stud projections to retain the modular door frame proximate to the trailer frame. In an example embodiment, the modular door frame may include a bottom frame member extending between respective bottom ends of the first and second side frame members and a top frame member extending between respective top ends of the first and second frame members, and the bottom frame member may include a locking plate. The locking plate may include a locking aperture through which a locking projection extending from the trailer frame passes to enable the modular door frame to be locked in proximity to the trailer frame. In some cases, the top frame member may include one or more lifting members extending upward from the top frame member, and an external door operator may engage the one or more lifting members to slide the modular door frame relative to the trailer frame to transition the automated operation assembly from the closed state to the automated open state.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

That which is claimed:

1. A modular door system for an over the road (OTR) trailer or protected truck body, the modular door system comprising:
a manually operated door assembly;
a manually operated lock system; and
a door frame structure configured to mount the manually operated door assembly and be removably connected to the OTR trailer or protected truck body.

2. The modular door system of claim 1, wherein the door frame structure comprises a modular door frame to selectively operably couple the modular door system to a trailer frame of the OTR trailer;
wherein the manually operated door assembly comprises a first hinged door panel operably coupled to a first side frame member on a first lateral side of the modular door frame and a second hinged door panel operably coupled to a second side frame member on a second lateral side of the modular door frame, the first and second hinged door panels being manually operable to swing between a closed state of the modular door and a manual open state in which the first and second hinged door panels are pivoted away from each other to provide access to a cargo space of the trailer; and
wherein the modular trailer door system further comprises an automated operation assembly operable between the closed state of the modular door and an automated open state in which the modular door frame is moved relative to the trailer frame to provide access to the cargo space of the trailer while the first and second hinged door panels remain proximate to each other.

3. The modular door system of claim 2, wherein the automated operation assembly comprises an external door operator providing power for movement of the modular door frame relative to the trailer frame.

4. The modular door system of claim 2, wherein the modular door frame moves relative to the trailer frame when transitioning to the automated open state without any part of the manually operated door assembly extending into the cargo space.

5. The modular door system of claim 2, wherein the modular door frame is completely removed from contact with the trailer frame in the automated open state.

6. The modular door system of claim 5, wherein the automated operation assembly comprises a first guide member operably coupled to a trailer frame first side member to define a first guide channel into which the first side frame member of the modular door frame is slidably received, and a second guide member operably coupled to a trailer frame second side member to define a second guide channel into which the second side frame member of the modular door frame is slidably received.

7. The modular door system of claim 6, wherein the first and second guide members are each L shaped brackets defining the first and second guide channels, respectively.

8. The modular door system of claim 6, wherein the first and second guide members each include a protruding member, and
wherein the protruding member protrudes into a receiving channel formed in the first and second side frame members, respectively.

9. The modular door system of claim 2, wherein one of the modular door frame or the trailer frame comprises a plurality of stud projections, and
wherein the other of the trailer frame or the modular door frame comprises a plurality of key hole receivers formed to receive respective instances of the stud projections to retain the modular door frame proximate to the trailer frame.

10. The modular door system of claim 2, wherein the modular door frame comprises a bottom frame member extending between respective bottom ends of the first and second side frame members and a top frame member extending between respective top ends of the first and second frame members, and
wherein the bottom frame member comprises a locking plate, the locking plate comprising a locking aperture through which a locking projection extending from the trailer frame passes to enable the modular door frame to be locked in proximity to the trailer frame.

11. The modular door system of claim 10, wherein the top frame member comprises one or more lifting members extending upward from the top frame member, and
wherein an external door operator engages the one or more lifting members to slide the modular door frame relative to the trailer frame to transition the automated operation assembly from the closed state to the automated open state.

12. An over the road (OTR) trailer comprising:
a trailer frame;
a cargo space bounded by the trailer frame;
a mobility assembly operably coupled to the trailer frame to enable mobility of the trailer frame; and
a modular door providing hybrid modes of operation including a manual mode and an automated mode, the modular door comprising:
a modular door frame to selectively operably couple the modular door to the trailer frame,
a manual operation assembly comprising a first hinged door panel operably coupled to a first side frame member on a first lateral side of the modular door frame and a second hinged door panel operably coupled to a second side frame member on a second lateral side of the modular door frame, the first and second hinged door panels being manually operable to swing between a closed state of the modular door and a manual open state in which the first and second hinged door panels are pivoted away from each other to provide access to the cargo space, and
an automated operation assembly operable between the closed state of the modular door and an automated open state in which the modular door frame is moved relative to the trailer frame to provide access to the cargo space of the trailer while the first and second hinged door panels remain proximate to each other.

13. The trailer of claim 12, wherein the automated operation assembly comprises an external door operator providing power for movement of the modular door frame relative to the trailer frame.

14. The trailer of claim 12, wherein the modular door frame moves relative to the trailer frame when transitioning to the automated open state without any part of the modular door extending into the cargo space, and
wherein the modular door frame is completely removed from contact with the trailer frame in the automated open state.

15. The trailer of claim 14, wherein the automated operation assembly comprises a first guide member operably coupled to a trailer frame first side member to define a first guide channel into which the first side frame member of the modular door frame is slidably received, and a second guide member operably coupled to a trailer frame second side member to define a second guide channel into which the second side frame member of the modular door frame is slidably received.

16. The trailer of claim 15, wherein the first and second guide members are each L shaped brackets defining the first and second guide channels, respectively, or
wherein the first and second guide members each include a protruding member, and the protruding member protrudes into a receiving channel formed in the first and second side frame members, respectively.

17. The trailer of claim 12, wherein one of the modular door frame or the trailer frame comprises a plurality of stud projections, and
wherein the other of the trailer frame or the modular door frame comprises a plurality of key hole receivers formed to receive respective instances of the stud projections to retain the modular door frame proximate to the trailer frame.

18. The trailer of claim 12, wherein the modular door frame comprises a bottom frame member extending between respective bottom ends of the first and second side frame members and a top frame member extending between respective top ends of the first and second frame members, and
wherein the bottom frame member comprises a locking plate, the locking plate comprising a locking aperture through which a locking projection extending from the trailer frame passes to enable the modular door frame to be locked in proximity to the trailer frame.

19. The trailer of claim 18, wherein the top frame member comprises one or more lifting members extending upward from the top frame member, and
wherein an external door operator engages the one or more lifting members to slide the modular door frame relative to the trailer frame to transition the automated operation assembly from the closed state to the automated open state.

20. A method manufacturing an over the road (OTR) trailer, the method comprising:
providing a trailer frame bounding a cargo space and mounted on a mobility assembly;
providing a door frame structure configured to be removably mounted to the trailer frame; and
mounting a manually operated door assembly in the door frame structure,
wherein the manually operated door assembly provides access to the cargo space via a manually operated lock system for locking and unlocking the manually operated door assembly, and
wherein access to the cargo space is alternatively provided by removing the door frame structure from the trailer frame.
